(19) United States
(12) Patent Application Publication
(10) Pub. No.: US 2006/0263606 A1
(43) Pub. Date: Nov. 23, 2006

(54) Glass texturing

(75) Inventors: Armin Gerhard Aberle, Botany (AU); Per Ingemar Widenborg, New South Wales (AU); Natapol Chuangsuwanich, New South Wales (AU)

Correspondence Address: KOLISCH HARTWELL, P.C., 200 PACIFIC BUILDING, 520 SW YAMHILL STREET, PORTLAND, OR, 97204, US

(73) Assignee: NewSouth Innovations Pty Limited, Sydney, New South Wales (AU)

(21) Appl. No.: 10/553,030

(22) PCT Filed: Mar. 19, 2004
(86) PCT No.: PCT/AU04/00339

§ 371 Date: Jun. 15, 2006

(30) Foreign Application Priority Data
Apr. 7, 2003 (AU) 2003901559

(51) Int. Cl. B05D 5/12; B05D 3/02; B05D 1/40; B32B 17/00

(52) U.S. Cl. 428/410; 427/58; 427/331; 427/372.2

(57) ABSTRACT

A method of texturing a glass surface is disclosed, the method comprising the steps of coating the glass surface with a material film, stimulating a reaction at the interface between the glass and the material film resulting in the formation of reaction products at the interface, and removing the material film and the reaction products from the glass surface. In a preferred embodiment, an aluminium film around 500 nm thick aluminosilicate is coated onto the glass and the stimulation is by heating. The aluminium reacts with the silica at temperatures between 500° C. and 630° C. to form reaction products that are then removed, along with the film, by etching with phosphoric acid. A further etch using HF/HNO₃ may also be employed. The method is particularly useful in etching glass substrates intended for use in photovoltaic devices.

### TECHNICAL FIELD

The present invention relates broadly to a method of texturing a glass surface, to a method of manufacturing a photovoltaic device, to a textured glass surface, and to a photovoltaic device.

### BACKGROUND

Textured glass surfaces are useful for a number of applications, including in photovoltaic devices or for applications in which it is desired to scatter light rays such that objects are no longer clearly visible through the glass.

In photovoltaic devices, light trapping is used to trap light in the active region of the device. The more light is trapped in the device the higher the light-generated photocurrent, and consequently the higher the energy conversion efficiency of the device. Therefore, light trapping is an important issue when trying to improve the conversion efficiency of photovoltaic devices and is particularly important in thin-film devices. Because most photovoltaic devices involve a glass pane, light trapping in these devices can be realised by texturing the glass pane.

Conventionally, chemical texturing or sand blasting are used for texturing glass panes. Alternative approaches have recently been disclosed for preparing textured glass surfaces. One of those approaches uses metal crystal deposits on a glass surface to form very fine crystals and thereby producing the glass texture effect. Another approach uses a liquid surface coating (“sol-gel”) containing SiO₂ spheres that, after densification, produces a textured glass surface.

However, these methods have specific disadvantages for photovoltaic device applications. Both chemical texturing and sand blasting can cause cracks and non-uniform feature size on the glass surface, which can adversely affect photovoltaic device fabrication and/or performance (for instance by causing electrical shunts in the devices). On the other hand, the use of fine metal crystals for making a textured glass surface appears to be quite an expensive method. Finally, it appears to be difficult to scale up the sol-gel method to very large dimensions (˜1 m²) as required for photovoltaic panels.

A need, therefore, exists to provide an alternative method of texturing a glass surface which addresses one or more of these disadvantages.

### DISCLOSURE OF THE INVENTION

In accordance with a first aspect of the present invention there is provided a method of texturing a glass surface, the method comprising the steps of coating the glass surface with a material film, stimulating a reaction at the interface between the glass and the material film resulting in the formation of reaction products at the interface, and removing the material film and the reaction products from the glass surface.

In one embodiment, the step of stimulating the reaction at the interface comprises a thermal annealing process. The thermal annealing process may comprise a sequence of annealing steps at different temperatures. The thermal annealing process may be conducted in a controlled ambient atmosphere.

The material film may comprise a single material or compound material.

The glass surface may initially be substantially flat.

The material film in one embodiment comprises aluminium. The reaction products may comprise aluminium oxide.

The step of removing the material film and the reaction products may comprise one or more etching steps. The etching steps may comprise a chemical etch.

The glass may comprise quartz, float glass, or non-float glass.

In accordance with a second aspect of the present invention there is provided a method of manufacturing a photovoltaic device, the method comprises the steps of texturing a glass surface utilising the method as defined in the first aspect, and depositing a semiconductor film on the textured glass surface, whereby the glass-facing surface of the semiconductor film exhibits substantially the same degree of texture as the glass surface.

In one embodiment, the semiconductor film is deposited in a manner such that substantially no gaps or voids exist between the textured glass surface and the semiconductor film.

The method may further comprise forming a dielectric barrier layer between the glass surface and the semiconductor. The dielectric layer may be formed on the textured glass surface prior to the deposition of the semiconductor film. The dielectric barrier layer may comprise silicon oxide or silicon nitride.

The semiconductor film may comprise a crystalline and/or an amorphous semiconductor material. The semiconductor material may comprise silicon.

In accordance with a third aspect of the present invention there is provided a textured glass surface formed utilising the method as defined in the first aspect.

In accordance with a fourth aspect of the present invention there is provided a photovoltaic device manufactured utilising the method as defined in the second aspect.

In accordance with a fourth aspect of the present invention there is provided a photovoltaic device comprising a glass pane having a textured surface a semiconductor film formed on the textured surface of the glass pane and having an internal absorption efficiency greater than about 0.5 for photons in a wavelength range from about 600 to 1200 nm.

### BRIEF DESCRIPTION OF THE DRAWINGS

Preferred embodiments of the invention will now be described, by way of example, with reference to the accompanying drawings in which:

FIGS. 1 to 4 are schematic drawings illustrating a method of texturing the surface of a glass pane, embodying the present invention.

FIG. 5 shows a FIB (focused ion beam) microscopical photograph of the top surface of a silicon-coated textured glass pane, embodying the present invention.

FIG. 6 shows a FIB microscopical photograph of a different region of the sample of FIG. 5.

FIG. 7 shows the measured light trapping properties of the sample of FIG. 5, compared with prior art samples.

### DETAILED DESCRIPTION AND BEST MODE

The embodiments described provide methods of texturing a glass surface suitable for use in the manufacturing of thin-film semiconductor photovoltaic devices.

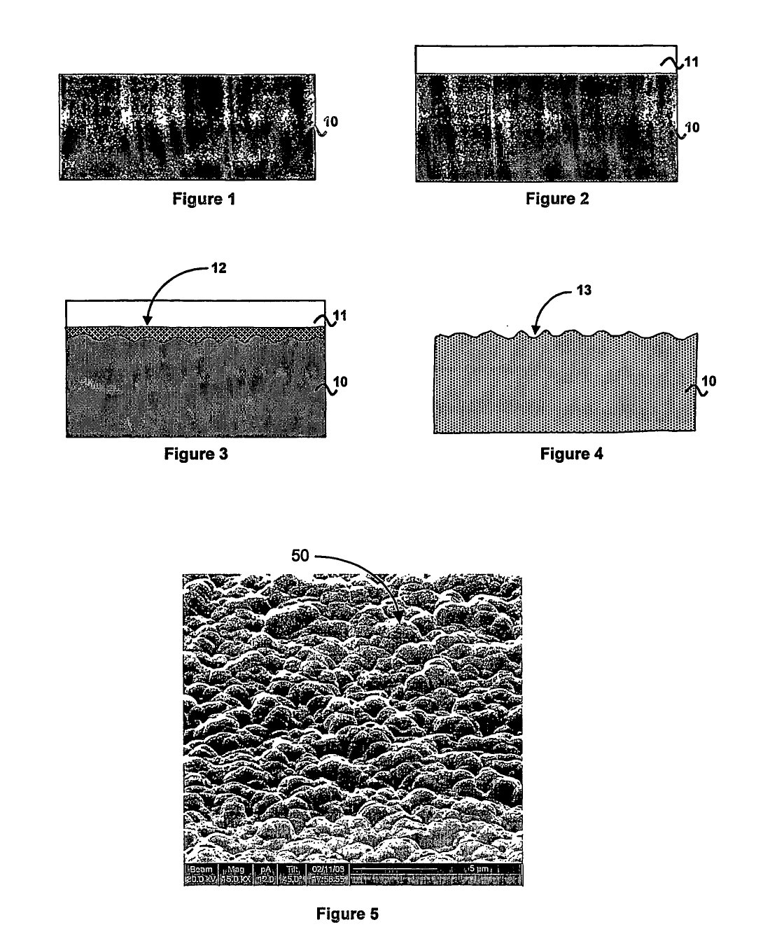

FIGS. 1 to 4 are schematic drawings illustrating a method of texturing the surface of a glass pane 10, embodying the present invention. FIG. 1 shows the glass pane 10, having a substantially flat upper surface and being a borosilicate glass in an example embodiment.

In a first step shown in FIG. 2, the glass pane 10 is coated with an aluminium film 11 utilising, in the example embodiment, thermal vacuum evaporation at about 10-5 Torr. In the example embodiment, the initial aluminium coating 11 is of a thickness of about 500 nm.

Next, the Al-coated glass pane is thermally annealed at elevated temperature, in the example embodiment in a two-step process with about 120 mins at about 500° C., followed by about 360 mins at about 620° C. in a nitrogen atmosphere.

In another embodiment, a three-step process with about 120 mins at about 500° C., followed by about 180 mins at about 560° C., followed by about 180 mins at about 630° C. in a nitrogen atmosphere may be applied.

It has been found by the applicants that the Al reacts spatially non-uniformly with the glass pane, forming reaction products in the form of mixtures (12 in FIG. 3) of aluminium oxide and silicon. A subsequent removal of both the A film 11 and the reaction products 12 forms a textured glass surface as schematically shown in FIG. 4. In the example embodiment, a 2-step chemical etch with about 10 mins in 85% phosphoric acid solution at about 110° C., followed by about 20 to about 45 secs in a 1:1HF/HNO₃ solution at room temperature was used to remove the reaction products 12 and aluminium film 11.

In another embodiment, a 2-step chemical etch with about 10 mins in phosphoric acid at about 110° C., followed by a second etch in a HF/HNO₃ solution at room temperature where the HF/HNO₃ ratio is in the range from about 1:1 to 1:20 is applied. Depending on the ratio used, a short ultrasonic waterbath treatment may be utilised after the second etching step to completely remove all reaction products.

It is noted here, that, depending on the type of removal technique, for example the type of etching solution, used, some amount of glass that has not reacted with the coating can also be removed, if desired.

Dimples (13 in FIG. 4) in the glass pane result from the removal of the Al/glass reaction products 12. The average size of the dimples can be adjusted over a wide range (from less than 1 μm to up to 10 μm) by e.g. selecting a suitable thermal annealing profile and/or a suitable removal technique for the Al/glass reaction products 12. This dimple size is well suited for thin-film photovoltaic applications because in those devices the semiconductor film thickness is typically in the range 0.5-3 μm.

In the example embodiment, the method textures the glass in such a way that there are no “overhanging” regions, i.e. when the textured glass pane 10 of FIG. 4 was illuminated by parallel light from above, there were no shaded regions within the dimples of the surface texture. This feature is advantageous for device applications, for instance if the subsequently formed semiconductor film needs to be in intimate contact with the glass everywhere (i.e., there must be no voids or gaps between the glass and the semiconductor film).

Another advantageous feature of textured glass samples embodying the present invention is that their transmission for light is only very weakly reduced by the texture.

FIG. 5 shows a FIB microscopical photograph of the top surface 50 of a silicon-coated textured glass pane fabricated using a method embodying the present invention. The silicon film is of polycrystalline nature and has a thickness of about 1.5 μm (i.e., similar to the dimensions of the texture features). It was created by thermal annealing (“solid-phase crystallisation”) of a plasma enhanced chemical vapour deposition (PECVD)-deposited amorphous silicon film. The striking feature of the surface 50 of the silicon coated glass pane is its cauliflower-like nature, caused by the textured glass surface [note that the silicon film has a planar, smooth top surface if fabricated on a non-textured (i.e., planar) glass pane]. The cauliflower-like top surface 50 of the silicon film is an indicator for good light trapping characteristics.

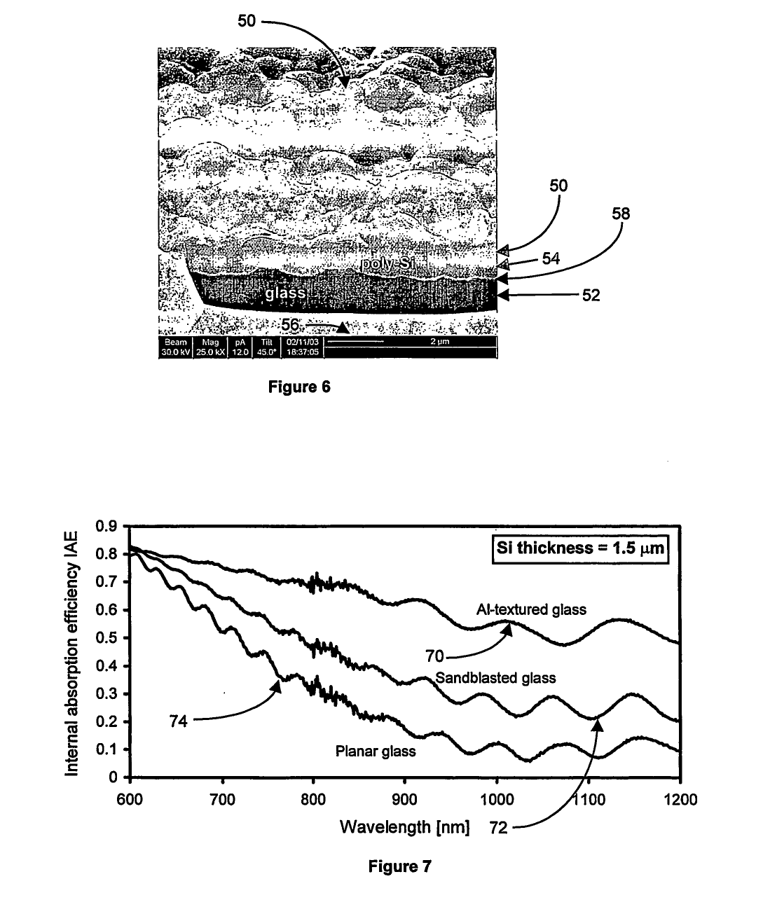

FIG. 6 shows a FIB microscopical photograph of a different region of the same sample, whereby additionally a trench was milled (using gallium ions) into the sample surface to reveal the cross-sectional properties of both the textured glass pane 52 and the polycrystalline silicon film 54 subsequently formed on the surface of the textured glass pane 52. The lateral marker 56 in FIG. 6 represents 2 μm. It can be seen that the poly-Si film 54 is everywhere in intimate contact with the surface of the textured glass pane 52 and that there are no voids or gaps between the glass pane 52 and the poly-Si film 54. This is advantageous for many device applications due to issues such as adhesion of the semiconductor film to the glass, long-term stability of the device, etc.

Another feature visible in FIG. 6, advantageous for good light trapping in thin-film photovoltaic devices, is the fact that in most regions of the sample the “top” and “bottom” surfaces 50 and 58 respectively of the poly-Si film 54 are sufficiently non-parallel, leading to the trapping of light due to the phenomenon of total internal reflection. However, it is noted that even if the two surfaces 50, 58 are substantially parallel, i.e. if the texture of the glass-facing surface 58 of the poly-Si film 54 is “directly transferred”, resulting in a corresponding texture on the surface 50 facing away from the glass 52, useful light trapping characteristics can still be achieved.

The light trapping can be further improved in actual devices by incorporating a back-surface reflector (BSR) (not shown) for near-infrared photons. The BSR can, for instance, be a silver or aluminium film. The BSR is either deposited onto the semiconductor film (if the sunlight enters the semiconductor through the glass) or onto the non-textured glass surface (if the semiconductor-coated, textured side of the glass faces the sun).

FIG. 7 shows that excellent light trapping is realised in thin (˜1.5 micron) polycrystalline silicon films formed on glass panes textured according to the described embodiment. The curve 70 labelled “Al-textured glass” was measured on the sample of FIG. 5. The plotted parameter is the measured internal absorption efficiency (IAE) which, for each wavelength, describes which fraction of those photons that entered the Si film is absorbed within the Si film. The higher the IAE the better the light trapping.

Also shown, for comparison, is the measured IAE of a 1.5-μm thick poly-Si film on a planar glass pane (curve 74) and on a sandblasted glass pane (curve 72). Clearly, the Al-textured glass provides by far the best light trapping of the three investigated structures. Note that the samples did not have a back surface reflector (BSR) during these optical measurements and hence the IAE of actual devices (such as thin-film photovoltaics) can be further improved by adding a suitable BSR.

It is further noted that glass panes textured in accordance with the described embodiment efficiently scatter light rays that pass through the glass panes, making them useful for other applications outside their use for photovoltaic devices. One such application is e.g. as glass panes for scattering windows or screens.

It will be appreciated by the person skilled in the art that numerous modifications and/or variations may be made to the present invention as shown in the specific embodiments without departing from the spirit or scope of the invention as broadly described. The present embodiments are, therefore, to be considered in all respects to be illustrative and not restrictive.

For example, it will be appreciated that the present invention is not limited to the dimensions and/or thin-film deposition techniques and/or reaction products removal techniques of the example embodiments described.

Furthermore, while in the embodiments described the glass texturing processes were optimised for borosilicate glass, it will be appreciated that the processing can be chosen and optimised for different glasses, including soda-lime glass, which is often used as a cheap window glass.

1. A method of texturing a glass surface, the method comprising the steps of:
coating the glass surface with a material film,
stimulating a reaction at the interface between the glass and the material film resulting in the formation of reaction products at the interface, and
removing the material film and the reaction products from the glass surface.

2. The method as claimed in claim 1, wherein the step of stimulating the reaction at the interface comprises a thermal annealing process.

3. The method as claimed in claim 2, wherein the thermal annealing process comprises a sequence of annealing steps at different temperatures.

4. The method as claimed in claim 2, wherein the thermal annealing process is conducted in a controlled ambient atmosphere.

5. The method as claimed in claim 1, wherein the material film comprises a single material or compound material.

6. The method as claimed claim 1, wherein the glass surface is initially substantially flat.

7. The method as claimed claim 1, wherein the material film comprises aluminium.

8. The method as claimed in claim 7, wherein the reaction products comprise aluminium oxide and/or silicon.

9. The method as claimed in claim 1, wherein the step of removing the material film and the reaction products comprises one or more etching steps.

10. The method as claimed in claim 9, wherein the etching steps comprise a chemical etch.

11. The method as claimed in claim 1, wherein the glass comprises quartz, float glass, or non-float glass.

12. A method of manufacturing a photovoltaic device, the method comprises the steps of texturing a glass surface utilizing a method as claimed in any one of the preceding claims, and depositing a semiconductor film on the textured glass surface, whereby the glass-facing surface of the semiconductor film exhibits substantially the same degree of texture as the glass surface.

13. The method as claimed in claim 12, wherein the semiconductor film is deposited in a manner such that substantially no gaps or voids exist between the textured glass surface and the semiconductor film.

14. The method as claimed in claim 12, wherein the method further comprises forming a dielectric barrier layer between the glass and the semiconductor.

15. The method as claimed in claim 14, wherein the dielectric layer is formed on the textured glass surface prior to the deposition of the semiconductor film.

16. The method as claimed in claim 14, wherein the barrier layer comprises silicon oxide or silicon nitride.

17. The method as claimed in claim 12, wherein the semiconductor film comprises a crystalline and/or an amorphous semiconductor material.

18. The method as claimed in claim 17, wherein the semiconductor material comprises silicon.

19. A textured glass surface formed utilizing a method as claimed in claim 1.

20. A photovoltaic device manufactured utilizing a method as claimed in claim 12.

21. A photovoltaic device comprising:
a glass pane having a textured surface; and
a semiconductor film formed on the textured surface of the glass pane and having an internal absorption efficiency greater than about 0.5 for photons in a wavelength range from about 600 to 1200 nm.

22-25. (canceled)
